(19) United States
(12) Patent Application Publication
(10) Pub. No.: US 2015/0266675 A1
(43) Pub. Date: Sep. 24, 2015

(54) METHODS AND APPARATUS FOR A CLEANSPACE FABRICATOR TO PROCESS PRODUCTS IN VESSELS

(71) Applicant: Frederick A. Flitsch, New Windsor, NY (US)

(72) Inventor: Frederick A. Flitsch, New Windsor, NY (US)

(21) Appl. No.: 14/663,829

(22) Filed: Mar. 20, 2015

Related U.S. Application Data
(60) Provisional application No. 61/969,583, filed on Mar. 24, 2014.

(51) Int. Cl. B65G 43/00

(52) U.S. Cl. CPC B65G 43/00

(57) ABSTRACT

The present disclosure provides various apparatus and methods for utilizing aspects of Cleanspace Fabricators. In some examples, methods relate to the material transport and processing involving Vessels or wells. The Vessels or wells may contain liquid or powder forms of materials.

### FIELD OF THE INVENTION

The present disclosure relates to methods and associated apparatus and methods which relate to processing tools used in conjunction with Cleanspace Fabricators. More specifically, the present disclosure relates to methods and apparatus to capitalize on the advantages of Cleanspace Fabricators for processing materials that may be contained in Vessels.

### BACKGROUND OF THE INVENTION

A known approach to advanced technology fabrication of materials such as semiconductor substrates is to assemble a manufacturing facility as a “cleanroom.” In such cleanrooms, processing tools are arranged to provide aisle space for human operators or automation equipment. Exemplary cleanroom design is described in: “Cleanroom Design, Second Edition,” edited by W. Whyte, published by John Wiley & Sons, 1999, ISBN 0-471-94204-9, (herein after referred to as “the Whyte text” and the content of which is included for reference in its entirety).

Cleanroom design has evolved over time to include locating processing stations within clean hoods. Vertical unidirectional airflow can be directed through a raised floor, with separate cores for the tools and aisles. It is also known to have specialized mini-environments which surround only a processing tool for added space cleanliness. Another known approach includes the “ballroom” approach, wherein tools, operators and automation all reside in the same cleanroom.

Evolutionary improvements have enabled higher yields and the production of devices with smaller geometries. However, known cleanroom design has disadvantages and limitations.

For example, as the size of tools has increased and the dimensions of cleanrooms have increased, the volume of Cleanspace that is controlled has concomitantly increased. As a result, the cost of building the Cleanspace, and the cost of maintaining the cleanliness of such Cleanspace, has increased considerably.

Tool installation in a cleanroom can be difficult. The initial “fit up” of a “fab” with tools, when the floor space is relatively empty, can be relatively straightforward. However, as tools are put in place and a fabricator begins to process substrates, it can become increasingly difficult and disruptive of job flow, to either place new tools or remove old ones. Likewise it has been difficult to remove a sub-assembly or component that makes up a fabricator tool in order to perform maintenance or replace such a subassembly or component of the fabricator tool. It would be desirable therefore to reduce installation difficulties attendant to dense tool placement while still maintaining such density, since denser tool placement otherwise affords substantial economic advantages relating to cleanroom construction and maintenance.

Included in the types of materials and products that may benefit from a clean environment for processing and transportation may be materials and products that may be contained within a Vessel, such as powders, emulsions, suspensions and liquids in a non-limiting sense. It would be desirable to define novel solutions for the processing of powders and liquids, which may include solutions that occur relate to clean environment processing.

### SUMMARY OF THE INVENTION

Accordingly, the present disclosure provides novel methods of utilizing the design for processing fabs which rearrange the clean room into a Cleanspace and thereby allow processing tools to reside in both vertical and horizontal dimensions relative to each other and in some examples with their tool bodies outside of, or on the periphery of, a clean space of the fabricator. The term fabricator has a meaning as defined herein but in some examples the term may be assumed to be related or may be the same entity as the vernacular meanings of the terms of factory, plant, production plant and the like. In some examples the transportation may occur in a Cleanspace region of high cleanliness. In other examples, the Cleanspace region may not have active cleanliness control.

In some such cases, the tool bodies can be removed and replaced with much greater ease than is the standard case. The design also anticipates the automated transfer of substrates and Vessels inside a clean space from a Tool Port of one tool to another. The substrates can reside inside specialized carriers designed to carry ones substrate at a time. Whereas, in some examples Vessels may themselves contain the product and act as a carrier.

Further design enhancements can entail the use of automated equipment to carry and support the Tool Body movement into and out of the fab environment. In this disclosure, numerous methods of using some or all of these innovations in designing, operating or otherwise interacting with such fabricator environments are described. The present disclosure can therefore include methods and apparatus for situating processing tools in a vertical dimension and control software modules for making such tools functional both within the Cleanspace type entity itself and also in networks of such fabricators.

In some examples of the disclosure, methods are provided which utilize at least one fabricator where the Cleanspace type region is vertically deployed. As previously mentioned, in some examples, the Cleanspace type region may define a design type regardless of the cleanliness within the Cleanspace type region. Within said fabricator there will be at least one and typically more tool chassis and toolPods. A toolPod will typically be attached to a tool chassis directly or indirectly thorough one or more other piece or pieces of equipment which attach to the toolPod. At least the one fabricator will perform a process in one of the toolPods and typically will perform a process flow which will be performed in at least one toolPod. The toolPod may have an attached or integral Toolport that is useful for the transport of substrates from one tool or toolPod to another tool or toolPod. In these examples, a unique aspect of the examples is that the first toolPod may be removed from the fabricator or factory for a maintenance activity or repair and then replaced with another toolPod. The use of the tool chassis together with a toolPod may result in a replacement that takes less than a day to perform. In some cases the replacement may take less than an hour. There may be numerous reasons for the replacement. It may be to repair the first toolPod or it may be replace the toolPod with another toolPod where the tool within is of a different or newer design type. These methods may be additionally useful to produce a product when the substrate produced by the process flow may next be processed with additional steps including those which dice or cut or segment the substrate into subsections which may be called chips. In some other examples the methods may be additionally useful to a product that may be contained in a Vessel. The products contained in a Vessel may include in a non-limiting sense powders, emulsions, suspensions and liquids.

In other examples of the disclosure, the toolPod may be useful for other methods relating to the development of tools. A toolPod in some examples may contain a subset of parts that are standard for a great many types of toolPods for example such parts may include control or computing systems, gas flow or liquid flow components, radio frequency signal generators, power supplies, clean air flow components, thermal regulation components and the like. A toolPod may therefore be formed in an incomplete form where a processing chamber is not present. It may be possible that only the processing chamber is not present or the processing chamber and some other components are not present. A method of developing a tool may involve taking the incomplete toolPod and designing a process chamber to go inside of it. Additional components to the process chamber may also be designed to go into the toolPod or in some examples changes to the standard components may be developed and implemented. The new designed toolPod comprising an incomplete toolPod and either or both of new chambers and new components may be produced. This newly designed tool in a toolPod may be tested for functionality. These tests may be performed on test stands that mate, support, connect or interact with the new toolPod. Alternatively, the tests may be performed by mating the toolPod with a Tool Chassis. The designer of the new tool may determine the functionality of the tool or alternatively a different entity may receive the new tool in a toolPod and perform the tests. A description of the function including a statement of qualification or something equivalent may be given. A different entity may offer the tool for sale, rent, leasing or as a portion of a larger entity that may be sold or leased.

In other examples of the disclosure, the fabricator described above and the methods described above may be repeated to occur in a multiple of fabricators. These combinations of fabricators may form a network of fabricators. The network of fabricators may have means of communication amongst and between the various fabricators. A method may involve a customer distributing a need for a part utilizing communication systems that interact with the individual fabricators. The communication of need for the part may be received in various fashions by the fabricator or affiliated users of the fabricators. The fabricator or user of the fabricator may assess the ability to provide a product meeting the need communicated and then utilize one or more of the networked fabricators to produce the product. In the process of designing such a part or more globally any part, the designing entity may elect to use intellectual property of others to form their product wherein said intellectual property has been duly offered for use either by free public domain type use or licensed use. The network or individual fabs may receive payments for the production of a product and may facilitate the payment of royalty payments to intellectual property holders as appropriate.

In some examples, the methods of producing products in the mentioned Cleanspace Fabricator types and the methods of developing tools may be utilized to define new entities for large scale manufacturing. By combining large numbers of small volume processing tools the fabricators may produce large amounts of product. In a unique manner, the tools may be further developed to simplify operations and thus lower cost. The simplification may include rationalizing the components and the design of processing chambers to the minimum or at least a lowered complexity so that limited processes may be performed in the tools. As an example, a mass flow controller capable of operation over a wide range of selectable gas flow requirements may be replaced with a pressure regulator and an orifice capable of providing a controllable flow within a single narrow flow condition.

In some examples, the methods of producing products in the mentioned Cleanspace Fabricator may be useful to produce small amounts of a product. In some cases the small amounts may be the early amounts of the product that will be produced in its lifetime. A user may produce these volumes with the intent of scaling up the production in other fabrication entities which may be of a Cleanspace or a cleanroom fabricator or other type. In some examples, using this process the user may produce a product in a number of process flows each intended to generate a product acceptable within that product's specifications but where the processing flow will allow the production to be performed in more than one large volume fabricator or in a selection of one amongst a number of large volume fabricators. In other aspects of this type of example the method of producing product in different process flows may be useful for the purpose of producing different populations of product where the performance aspect of the different populations may be compared against each other. A designer may utilize such performance comparisons to produce one of the types of flows or alternatively more than one grade of product in multiple production environments.

In some examples, the methods of utilizing Cleanspace Fabricators that have been discussed involve the removal of a toolPod from a fabricator or factory. After such removal, in some examples the toolPod may be disposed of. In other examples, the toolPod may be recycled. In still other examples the toolPod may be sent to a maintenance facility. The maintenance facility may be located within the confines of the business entity which removed the toolPod or alternatively in a remote maintenance facility. If the maintenance will be prepared in a remote facility the toolPod may be shipped by various means including land transportation of automobiles, trucks, or trains or similar conveyances or by water transportation including ships for example or by air transportation means. In some examples, once the toolPod reaches a maintenance facility it may be transported to a location within a Cleanspace or a cleanroom where maintenance activity may be performed. In the performance of the maintenance activity the toolPod may be disassembled at least in part to allow for access of maintenance personnel or equipment to components within the toolPod. Alternatively automated diagnostic equipment may perform tests and perform maintenance without a disassembly step in some cases. After the toolPod is maintained it may be reassembled as necessary and then tested. It may be tested on a test stand or placed upon a tool chassis. The tests may involve functional tests of the components or involve tests upon substrates which are monitors or substrates representative of product. The toolPod may thereafter be shipped to the same location it came from or another different location. At the same location, if shipped there it may be placed at a later time on the same Tool Chassis it was mated with previously or alternatively it may be placed on a different Tool Chassis.

In some examples of the disclosure, novel methods of research and development may be performed. Utilizing the methods related to Cleanspace Fabricators that have been mentioned or are mentioned in other sections of this specification, at least one of the toolPods utilized may be an experimental tool design. Alternatively, an established tool design may be used for an experimental process module. Alternatively, experimental assembly or packaging techniques may be performed on the resulting substrate of the Cleanspace Fabricator or in Cleanspace Fabricators themselves. The processing may involve the use of new processing flows at least in part in toolPods within Cleanspace Fabricators of various types. The processing may involve new designs produced in processing flows at least in part in toolPods within Cleanspace Fabricators of various types.

There may be combinations of toolPods and tool Chassis entities which reside in environments that resemble either Cleanspace or cleanroom environments which represent novel methods based on the inventive art herein. For example, a vertically deployed Cleanspace may exist in an environment where there is only one vertical level in the fabricator or where there are no toolPods located in a vertical orientation where at least a portion of a toolPod lies above another in a vertical direction. Alternatively, whether in only one vertical level or in multiple levels of a Cleanspace Fabricator type whether vertically deployed or not there may be novel examples of the inventive art herein that involve collections of toolPods that are functional to produce on a portion of a process flow or even a portion of a process but utilize the methods described for fabricators and are novel as well.

For all the methods of producing product mentioned, a novel aspect of the present disclosure may be the processing of liquids and powders in the environments. A Vessel may be used to contain the product as it is processed. In a non-limiting sense the Vessel may include devices with wells or reservoirs of various types. A tube type Vessel may be used for Vessel processing examples and may include features such as end caps and regions of the end caps that allow for injection or product material into the Vessel by various means. The production processes based upon Vessel production may create a wide diversity of product types including in a non-limiting sense high purity chemical products, pharmaceuticals and biological growth products. Combinations of processing may also involve the processing of liquids or powders intermixed with steps that involve processing on substrates. In some examples, the environment of primary and Secondary Cleanspace regions as well as regions within toolPods may have sterile, antiseptic or antibiological aspects that may be supplementary to the particulate control and may involve, in a non-limiting sense, high energy sources such as UV light, chemical sterilizing materials and such techniques.

One general aspect includes a method for processing a Vessel including forming a fabricator including at least a first vertically deployed Cleanspace, at least a first tool chassis and at least a first toolpod attached to the first tool chassis. The method may additionally include processing a first Vessel in the first toolpod, handling the first Vessel at a toolport of the first toolpod within the first vertically deployed Cleanspace, removing the first toolpod from the fabricator from outside a Primary Cleanspace for repair, and placing a second toolpod upon the first tool chassis.

Implementations may include one or more of the following features. The method where the second toolpod includes a toolpod of a newer design. The method where the processing of the first Vessel forms a product that contains one or more of a pharmaceutical, an intermediate in the production of a pharmaceutical, or a material with pharmaceutical properties.

One general aspect includes a fabricator where a first processing tool includes a Tool Port that receives Vessels from the fabricator automation; a Tool Body that is interfaced to fabricator facilities including one or more of utilities, chemicals and gases; and at least a first integrated chamber or processing region. The fabricator additionally may include two or more flanges, each flange sealed to a respective opening in at least one of the vertical walls, each said flange additionally sealable to one of the plurality of fabrication tools. The fabricator may include examples where the removal in a discrete fashion removes the tool from a Secondary Cleanspace. The fabricator may include examples where a material to be processed by the plurality of tools can be transferred from a port of the first processing tool to a port of the second processing tool through the Primary Cleanspace. The fabricator may also include examples where each processing tool is capable of independent operation and is removable such that the removing does not prevent the operation of other processing tools. The fabricator may include examples where the Vessel contains a pharmaceutical, an intermediate in the production of a pharmaceutical, or a material with pharmaceutical properties. The fabricator may additionally include means for interfacing a Tool Body to a tool chassis, where the means for interfacing establishes an interface between the Tool Body and the fabricator facilities. The fabricator may include examples where the first vertical wall and the second vertical wall are essentially planar. The fabricator may include examples where each flange facilitates the containment of air within the Primary Cleanspace, and at least a first Tool Port of the first processing tool is within the Primary Cleanspace while the first Tool Body of the first processing tool is external to the Primary Cleanspace. The fabricator may include examples where a floor is located above at least a portion of the first level of processing tools, and the floor is beneath at least a portion of the second level of processing tools. The fabricator may additionally include means for locating a Tool Body upon a tool chassis in at least an extended position and a closed position, where when the means for locating the Tool Body locates the Tool Body in the extended position the Tool Body may be removed from the tool chassis. The method of processing Vessels may include examples where the content is a liquid. The method of processing Vessels may additionally include the step of performing a process on a content of the Vessel in the second processing tool. The method of processing substrates may additionally include the steps of replacing the first processing tool with a second processing tool from a peripheral location, such that the replacing does not prevent the operation of other processing tools in the fabricator.

One general aspect includes a fabricator for containing a plurality of processing tools, the fabricator may include a Vessel, where the Vessel is capable of being handled by a fabricator automation system; multiple levels of processing tools, where at least a second level of processing tools is oriented vertically above at least a first level of processing tools, where a first processing tool on the first level of processing tools and a second processing tool on the second level are configured to process the Vessel; a Primary Cleanspace bounded in part by a first vertical wall and a second vertical wall, where said Primary Cleanspace is located between the first vertical wall and the second vertical wall, where within the Primary Cleanspace the Vessel may be transported from the first level of processing tools to the second level of processing tools; and an air source for providing air flow through the Primary Cleanspace from the first vertical wall to the second vertical wall.

Implementations may include an example where a first processing tool includes a Tool Port that receives Vessels from the fabricator automation; a Tool Body that is interfaced to fabricator facilities including one or more of utilities, chemicals and gases; and at least a first integrated chamber or processing region. The fabricator may additionally include two or more flanges, each flange sealed to a respective opening in at least one of the vertical walls, each said flange additionally sealable to one of the plurality of fabrication tools.

The fabricator may include examples where removal of a tool in a discrete fashion removes the tool from a Secondary Cleanspace. The fabricator may also include examples where a material to be processed by the plurality of tools can be transferred from a port of the first processing tool to a port of the second processing tool through the Primary Cleanspace. The fabricator may additionally include examples where each processing tool is capable of independent operation and is removable such that the removing does not prevent the operation of other processing tools. The fabricator may include examples where the Vessel contains a pharmaceutical, an intermediate in the production of a pharmaceutical, or a material with pharmaceutical properties.

In some examples, the fabricator may include examples where a floor is located above at least a portion of the first level of processing tools, and the floor is beneath at least a portion of the second level of processing tools. The fabricator may additionally include means for locating a Tool Body upon a tool chassis in at least an extended position and a closed position, where when the means for locating the Tool Body locates the Tool Body in the extended position the Tool Body may be removed from the tool chassis.

Implementations may include the method of processing Vessels where the content is a liquid. The method of processing Vessels may additionally include the step of performing a process on a content of the Vessel in a second processing tool. The method of processing substrates may additionally include the steps of replacing the first processing tool with a second processing tool from a peripheral location, such that the replacing does not prevent the operation of other processing tools in the fabricator.

One general aspect may include a method of processing Vessels including the step of moving a Vessel within a Primary Cleanspace included within a fabricator from a first processing tool to a second processing tool, where the Primary Cleanspace includes a first vertical wall and a second vertical wall, where an air source within the fabricator provides air flow through the Primary Cleanspace from the first vertical wall to the second vertical wall, and where the first processing tool is located on a first level of processing tools and the second processing tool is located on a second level of processing tools.

One general aspect includes the method of processing Vessels where the content is a powder.

Implementations may include one or more of the following features. The method of processing Vessels may include examples where the content is a liquid. The method of processing Vessels may additionally include the step of performing a process on a content of the Vessel in the second processing tool. The method of processing substrates may additionally include the steps of: replacing the first processing tool with a second processing tool from a peripheral location, such that the replacing does not prevent the operation of other processing tools in the fabricator.

### BRIEF DESCRIPTION OF THE DRAWINGS

The accompanying drawings, that are incorporated in and constitute a part of this specification, illustrate several examples of the disclosure and, together with the description, serve to explain the principles of the disclosure:

FIG. 1—A depiction of the changes related to Cleanspace type designed fabricators and the size differences that are possible from the state of the art.

FIG. 2—An illustration of a small tool Cleanspace Fabricator in a sectional type representation whose primary region of material transport may exist between vertical walls spanning multiple vertical levels.

FIGS. 3A-3L—Illustrations of different types of Cleanspace type designs that may define fabricators or be replicated within a fabricator.

FIG. 4—An illustration of an exemplary Cleanspace type design with multiple types of automation designs.

FIG. 5A-5F—Illustrations of exemplary types of manufacturing process flows.

FIG. 6—An illustration of an exemplary Chassis Example.

FIG. 7—An illustration of an exemplary Chassis Example from a Front View with Tool Body Placed.

FIG. 8—An illustration of an exemplary Chassis Example from a Rear View with Tool Body Placed.

FIG. 9—An illustration of an exemplary Placement in an Exemplary Fab Design.

FIG. 10—An illustration of an exemplary chassis design that may be viewed without an exemplary toolPod placed thereupon.

FIG. 11—An illustration of an exemplary view of a vertical type fabricator design wherein Tool Ports from different tools may be observed.

FIGS. 12A-12D—Illustrations of exemplary Vessels that may be used for processing in the various types of exemplary fabricators.

FIG. 13—An illustration of an exemplary toolPort handling an exemplary Vessel.

### DETAILED DESCRIPTION

In patent art by the same inventive entity, the innovation of the Cleanspace Fabricator has been described. In place of a cleanroom, fabricators of this type may be constructed with a Cleanspace that contains the wafers, typically in containers, and the automation to move the wafers and containers around between ports of tools. The Cleanspace may typically be much smaller than the space a typical cleanroom may occupy and may also be envisioned as being turned on its side. In some examples, the processing tools may be shrunk which changes the processing environment further. A novel use of this fabricator environment may be when the production unit, described as the substrate is altered to comprise a Vessel. A Vessel may contain and support rather than simply support results of production processes which may include fluids, powders, emulsions, suspensions and other forms that are contained within a Vessel.

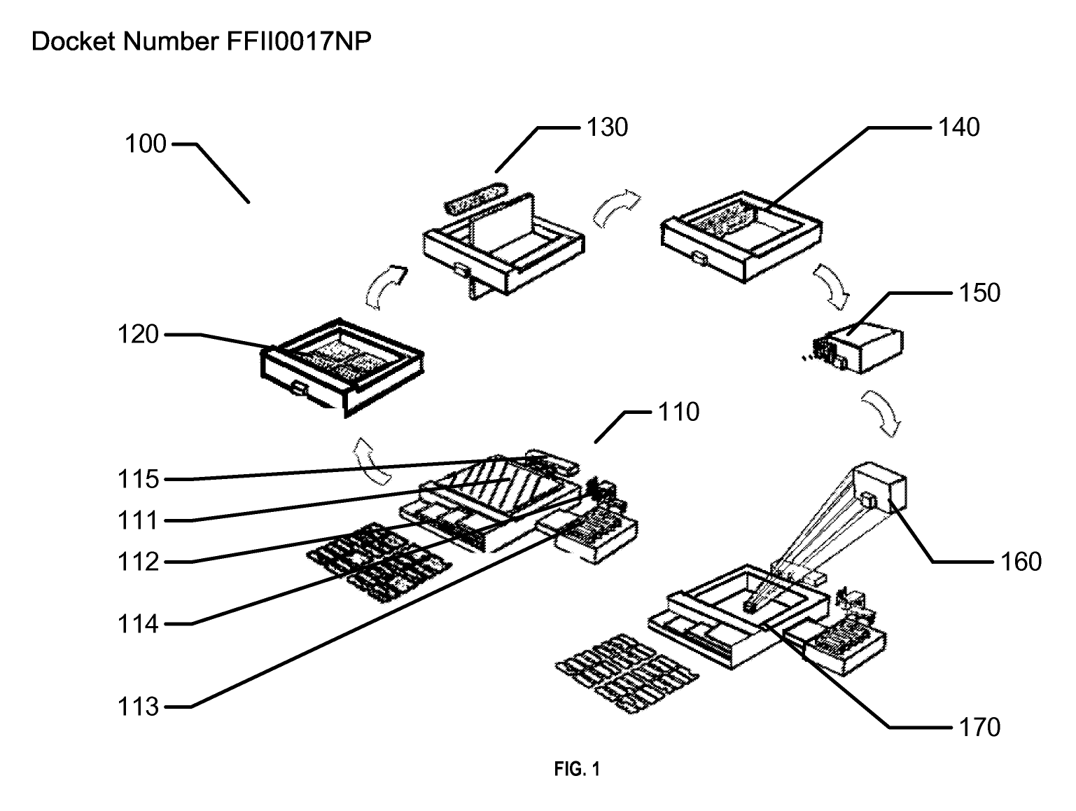

In FIG. 1 100, a depiction of the changes possible with a Cleanspace type fabricator is described. A typical cleanroom based fabrication site 110 is depicted. There may be the cleanroom 111, office space 112 for the various functions to support the production, facilities 113 to control and generate the necessary utilities including clean room air which may be temperature and humidity controlled, facilities for gasses and chemicals 114. As well there may be safety and fire control operations 115.

Continuing on FIG. 1, the advantages of a Cleanspace Fabricator allow for less capacity needs for the support facilities. Especially when the fabricator is focused in small volumes these facilities may be greatly reduced. The representation shows the cleanroom 120 space alone where the tools are now seen through the ceiling of the facility which would be where the cleanroom air filters would typically be located. The size of the cleanroom is still roughly 6 football fields in size. This depiction may represent the reduced site services aspect of Cleanspace Fabricators.

In some examples of a Cleanspace Fabricator, the cleanroom may be replaced with the Cleanspace. A representation of a change 130 in the cleanroom may be depicted. In some examples, a Cleanspace may be envisioned by the process of rotating a fab's cleanroom on its side. After this, the dimension of the thus rotated cleanroom may then be shrunk by up to a factor of tenfold. The tools are represented as being removed from the cleanroom environment and “hovering” about the facility. This changed Cleanspace dimension is one of the reasons for the reduced amount of site service requirements.

Proceeding further, the placement in some examples of tooling in a vertical dimension 140. The tools that were hovering above the facility are now shown as being oriented next to the Cleanspace environments in a vertically oriented or stacked orientation. These tools have a portion in the Cleanspace and also a region external to the Cleanspace and thus all exist on the periphery. Therefore, the representation may also depict the peripheral tool access aspect of the Cleanspace Fabricator. What may be apparent is that this type of orientation of the tooling also allows for the further shrinkage of the fabricator dimension required.

In some examples, a shrunken version of the fab due only to the orientation of tooling may result even when the same numbers of tools are utilized. However, due to a variety of aspects of the Cleanspace Fabricator, there may be operational modes that make business sense to organize a minimal number of tools into a Cleanspace type facility. Such a reduced number of tools may result in the reduced fab footprint 150. However, still further examples of the operational and business models may derive if the tools themselves are reduced in size so that they process wafers that are roughly 2 inches in diameter or at least significantly smaller than standard dimensions. Another point made in the depiction shows that the tools may be shrunken to create another version of the Cleanspace Fabricator.

The figure depicts the further reduced footprint of a Cleanspace Fabricator whose purpose in some examples may be a focus on activities of small volume 160. In these type of examples, the small tools occupy less space than large tools further reducing the space of the Cleanspace and thus the site support aspects of fabricators the extreme of which has been depicted in the figure starting with the cleanroom 120. If such a prototype fabricator with activities of small volume 160 is placed within the original footprint 170 it may be clear the significant scale differences that are possible.

### Description of a Linear, Vertical Cleanspace Fabricator

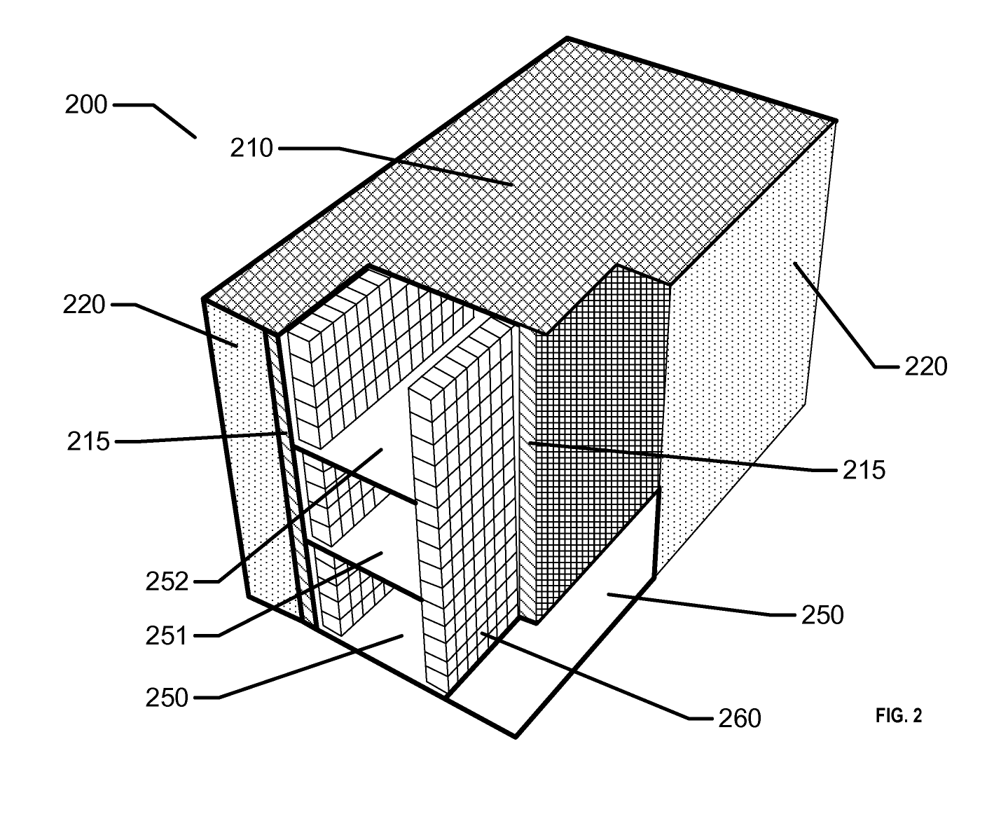

There are a number of types of Cleanspace Fabricators that may be possible with different orientations. For the purposes of illustration one exemplary type where the fab shape is planar with tools oriented in vertical orientations may be used. This type may result in the depictions shown in FIG. 1. An exemplary representation of what the internal structure of these types of fabs may look like is shown in a partial cross section representation in FIG. 2, 200. The depiction may represent the roof 210 of such a fabricator where some of the roof has been removed to allow for a view into the internal structure. Additionally, the depiction may represent the external walls 220 of the facility which are also removed in part to allow a view into external structure.

In the linear and vertical Cleanspace Fabricator of FIG. 2 there are a number of aspects that may be observed in the representation. The “rotated and shrunken” Cleanspace regions 215 may be observed. The occurrence of Cleanspace regions 215 on the right side of the figure is depicted with a portion of its length cut off to show its rough size in cross section. The Cleanspaces lie adjacent to the tool pod locations. The small cubical features represent tooling locations 260 within the fabricator. These locations are located vertically and are adjacent to the Cleanspace regions 215. In some examples a portion of the tool, the Tool Port, may protrude into the Cleanspace region to interact with the automation that may reside in this region.

The depiction may represent the fabricator floor 250 or ground level. On the right side, portions of the fabricator support structure may be removed so that the section may be demonstrated. In between the tools and the Cleanspace regions, the location of the fabricator floor 250 may represent the region where access is made to place and replace tooling. In some examples, as in the one in FIG. 2, there may be two additional floors that are depicted as floor two 251 and floor three 252. Other examples may have now flooring levels and access to the tools is made either by elevator means or by robotic automation that may be suspended from the ceiling of the fabricator or supported by the ground floor and allow for the automated removal, placement and replacement of tooling in the fabricator.

Description of a Chassis and a toolPod or a Removable Tool Component

A toolPod and a toolPod's chassis is relevant to Cleanspace operations. These constructs, which in some examples may be ideal for smaller tool form factors, allow for the easy replacement and removal of the processing tools. Fundamentally, the toolPod may represent a portion or an entirety of a processing tool's body. In cases where it may represent a portion, there may be multiple regions of a tool that individually may be removable. In either event, during a removal process the tool may be configured to allow for the disconnection of the toolPod from the fabricator environment, both for aspects of handling of product substrates and for the connection to utilities of a fabricator including gasses, chemicals, electrical interconnections and communication interconnections to mention a few. The toolPod represents a stand-alone entity that may be shipped from location to location for repair, manufacture, or other purposes.

Process of an Application or “Apps” Model for Tool Design Using the toolPod Construct.

These toolPod constructs represent a novel departure from the state of the art in fabricator tooling where a tool is assembled (sometimes on a fabricator floor) and rests in place until it is decommissioned for that Fabricator. Because there are many similar functions that process tools require to operate, the toolPod for many tool types can be exactly the same with the exception of a region where the different processing may occur. In some other cases, the tool type may require different functions in the toolPod and Chassis like for example the handling of liquid chemicals as an example. Even in toolPods of this type there may be a large amount of commonality in one type of toolPod to another. This creates an infrastructure where the numbers of common components in processing tools in the industry can be large allowing for economies of scale. Additionally, these toolPods, which may result in economic costs due to the economies of scale mentioned, may provide the ideal infrastructure both for a common definition of tooling solutions for common tasks as well as an economical starting point for the development of new types of tooling or different models of existing types of tooling.

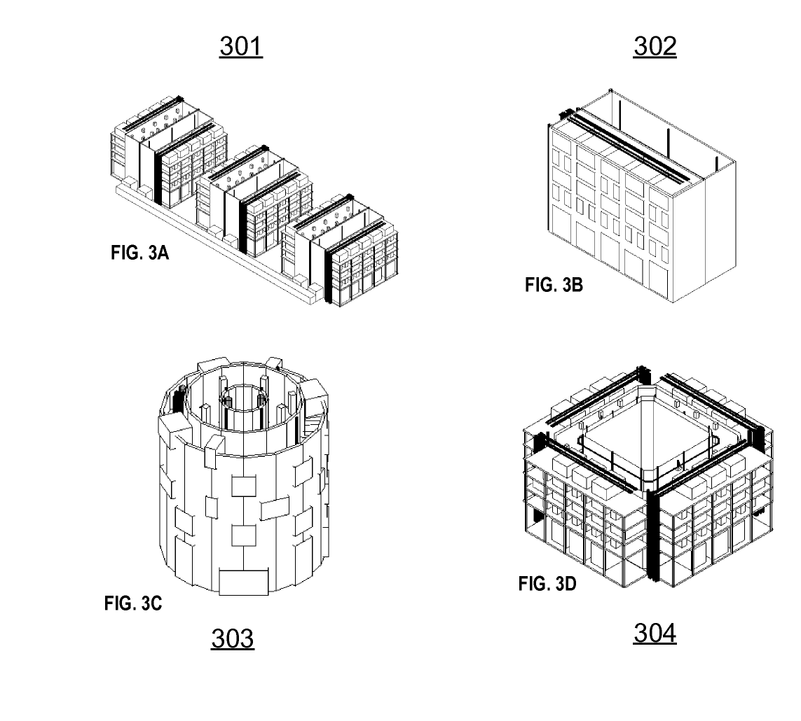

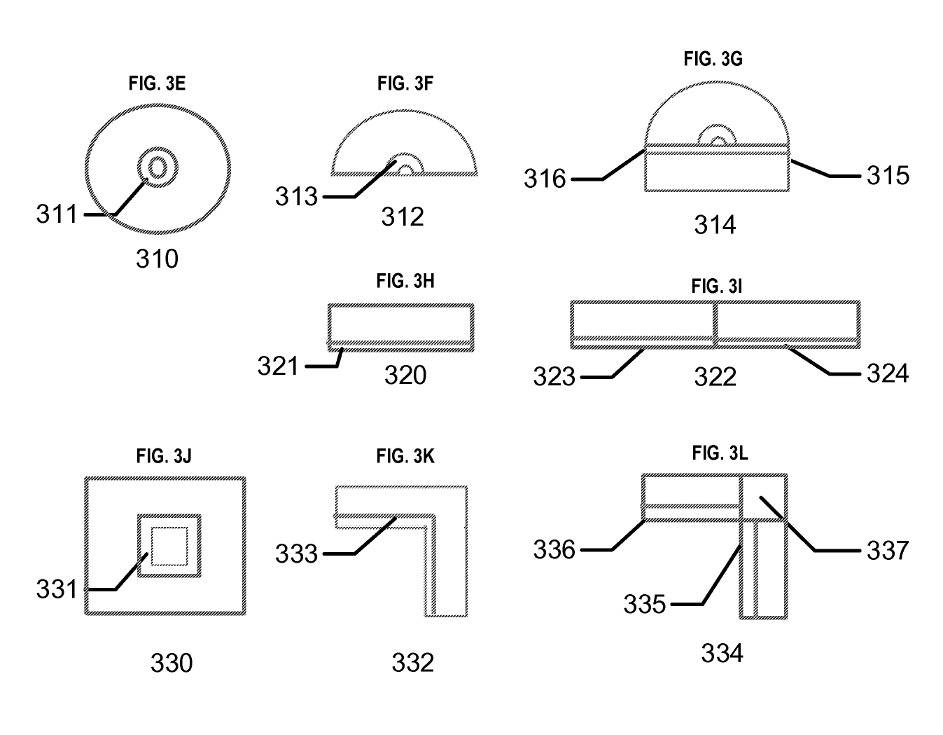

There are numerous types of Cleanspace Fabricators that may be consistent with the art described herein. Much of the discussion has been made in connection to vertically oriented, generally planar examples of a Cleanspace. Referring to FIG. 3B, various examples may be shown in a depiction of the general shape of such planar vertically oriented Cleanspace Fabricators 302. However, numerous other types of Cleanspace Fabricators and combinations of Cleanspace Fabricators may be consistent with the art herein. For example, compound versions 301 of the generally planar, vertically oriented fabs may be observed in FIG. 3A. There may also be tubular and annular tubular types of designs. FIG. 3C depicts a round annular tubular type Cleanspace Fabricator 303; while, FIG. 3D may depict a rectilinear annular tubular type Cleanspace Fabricator 304. The exact nature of the Cleanspace Fabricator, as may be apparent, may exist in all the diversity of types of Cleanspace Fabricators and be consistent with establishing a retrofitting of existing manufacturing lines into Cleanspace Fabricators.

In FIGS. 3E, 3F, 3G, 3H, 3I, 3J, 3K and 3L, there are various examples of Cleanspace Fabricators and some exemplary derivations of those types that form fabricators with multiple Cleanspace environments associated with processing substrates to different requirements of cleanliness of environment where the multiple environments are at a collocated site. There may be a round annular tubular Cleanspace Fabricator 310 and a typical location of a Primary Cleanspace 311 in such a fabricator. There may be a rectilinear annular tubular Cleanspace Fabricator 330 with its exemplary Primary Cleanspace 331.

From these two basic Cleanspace Fabricator types, a number of additional fab types may be formed by sectional cuts of the basic types. A sectional cut may result in a hemi-circular shaped fabricator 312 with its exemplary Primary Cleanspace 313. A section cut of a rectilinear annular tubular Cleanspace Fabricator 330 may result in an essentially planar Cleanspace Fabricator 320, similar to that discussed in previous figures, where the Primary Cleanspace 321 is represented. And in another non-limiting example, a compound Cleanspace Fabricator 332 may result from a sectional cut of a rectilinear annular tubular Cleanspace Fabricator 330 where it too may have a Primary Cleanspace 333 indicated.

When these various fabricator types are combined with copies of themselves or other types of Cleanspace Fabricators, a new type of Cleanspace Fabricator may result which is a composite of multiple Cleanspace environments. A few of numerous combinations are depicted. For example, a first combination fab 314 may represent a combination of a first fabricator of a hemi-circular shaped fabricator 312 type with a second fabricator of a planar Cleanspace Fabricator 320 type. Cleanspace 316 may represent a first Cleanspace environment in this composite fab, Cleanspace 315 may represent a second type of Cleanspace environment. Alternatively, a second combination fab 322 may be formed by the combination of two versions of the essentially planar Cleanspace Fabricator 320 type, where the two different Primary Cleanspace environments 323 and 324 are shown. Another exemplary result may derive from the combination of two fabricators of the essentially planar Cleanspace Fabricator 320 type as shown in third combination fab 334. Third combination fab 334 may have two different Primary Cleanspace regions 336 and 335. And, in some examples, Primary Cleanspace 337 may represent a third Cleanspace region. It may be apparent that the generality of combining two different Cleanspace elements to form a composite fabricator may be extended to cover fabs made from combinations of 3 or more fabricator Cleanspace elements.

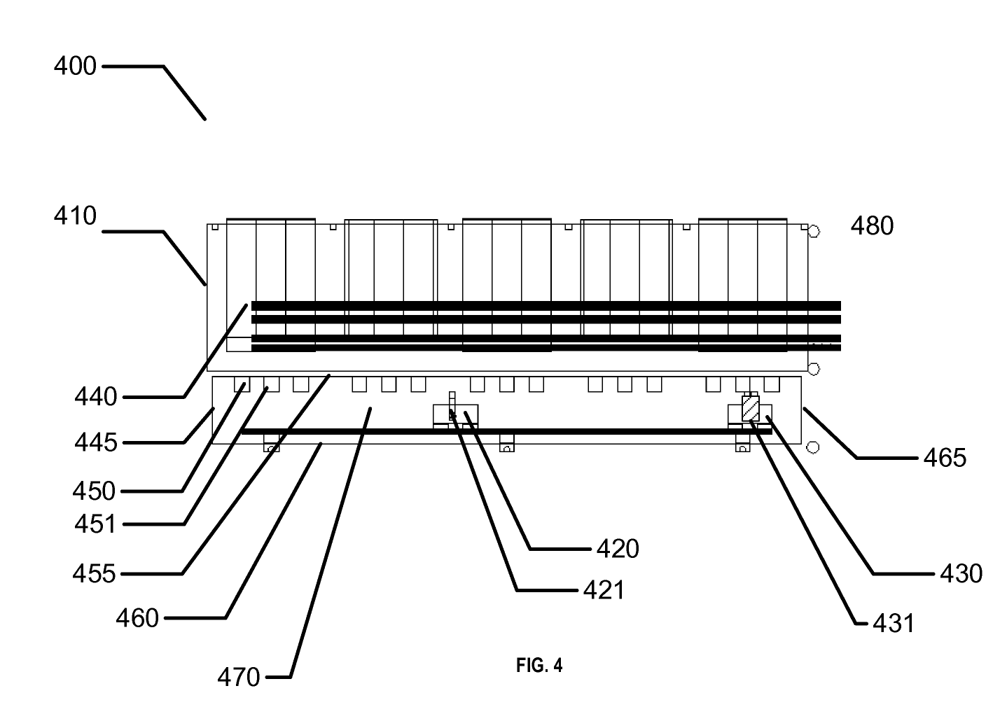

An alternative type of Cleanspace environment for processing of multiple types of substrates, or multiple types of Vessels or combinations of substrates and Vessels may be represented in FIG. 4, 400. In a fabricator 410 of this type, there may be a Cleanspace environment 470. In some examples, this Cleanspace may be defined by a unidirectional airflow flowed from or through wall 455 to wall 460 where walls 445 and 465 are flat walls. It may be clear that the various diversity described previously may include art consistent with the inventive art herein. And in some examples, there may be a Tool Port 450 which resides significantly in the Cleanspace environment 470, which may be called a fabricator Cleanspace in some examples, while a Tool Body 440 resides outside this Cleanspace environment 470.

In some examples, the cleanliness of the Cleanspace environment 470, may be uniformly at the highest specification required for any of the processing in the fabricator environment. In such examples, therefore, the environment may exceed the needs of other processing steps that are performed within it. Since there may be multiple types of substrates and/or Vessels processed in the environment, as for example wafers, die form, liquids, powders, emulsions, or suspensions in a non-limiting sense, there may need for multiple different types of automation present to move substrates or Vessels from Tool Port to Tool Port. For example, the depiction may represent a robot 420 that is capable of moving wafer carriers through the use of a robotic arm 421. And, there may be a piece of automation 430 that is capable of moving Vessels through use of a different robotic arm 431, from Tool Port to Tool Port. In fabricators of this type, in some examples there may be tools that have two different types of Tool Port on them, one consistent with handling a first type of substrate like for example wafer carriers and another capable of handling Vessels.

In some examples, in a non-limiting sense, such a tool might include a tool for performing a chemical separation. In this case, carriers with substrates may be input into the tool through one port shown for example as Tool Port 450 and then Vessels may leave the tool through Tool Port 451.

Other manners of processing multiple substrates or Vessels may include for example tools which take substrate carriers or Vessels from an external environment 480 to the Cleanspace Fabricator and place them into the Cleanspace environment through a Tool Port. In a similar fashion, substrates or Vessels in various types of carriers may also exit the fabricator environment through a processing tool to an external environment 480 as well. Alternatively there may be other means to directly introduce or remove substrate carriers into the Cleanspace environment directly through a Cleanspace wall, for example through wall 445.

In any of the Cleanspace Fabricator examples where multiple types of substrates or Vessels are processed within a single type of Cleanspace environment there may be need for multiple types of automation. This may be true for the type of single fabricator environment shown in FIG. 4, 400 or alternatively for the composite types shown previously where multiple substrate types are processed. It may be clear, that another example may derive where the automation devices, like robot 420, are capable of handling multiple substrate carrier or Vessel types or both.

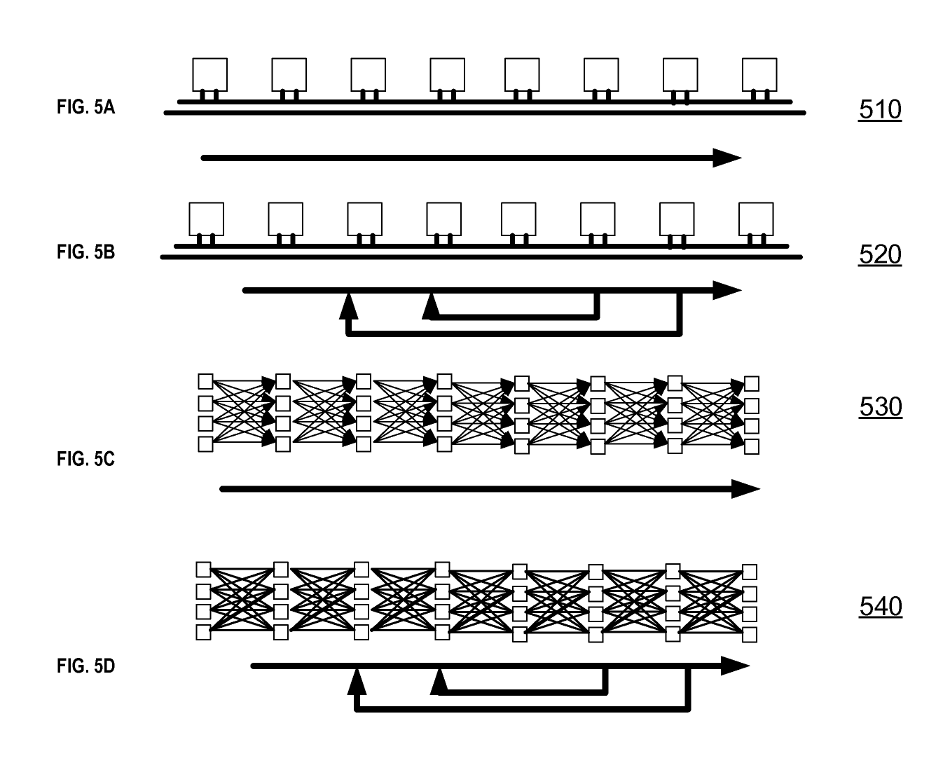

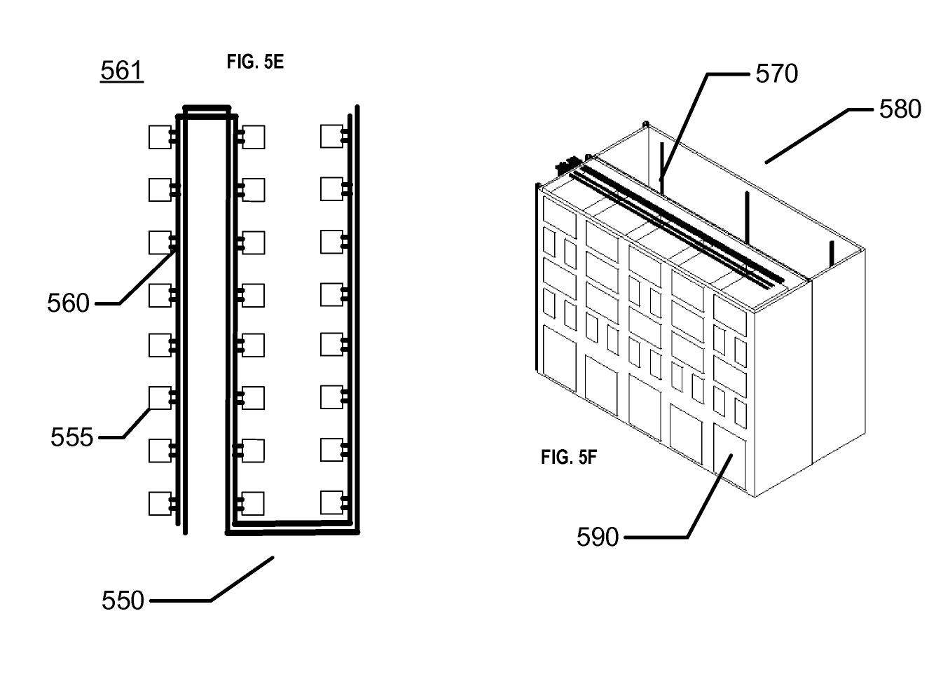

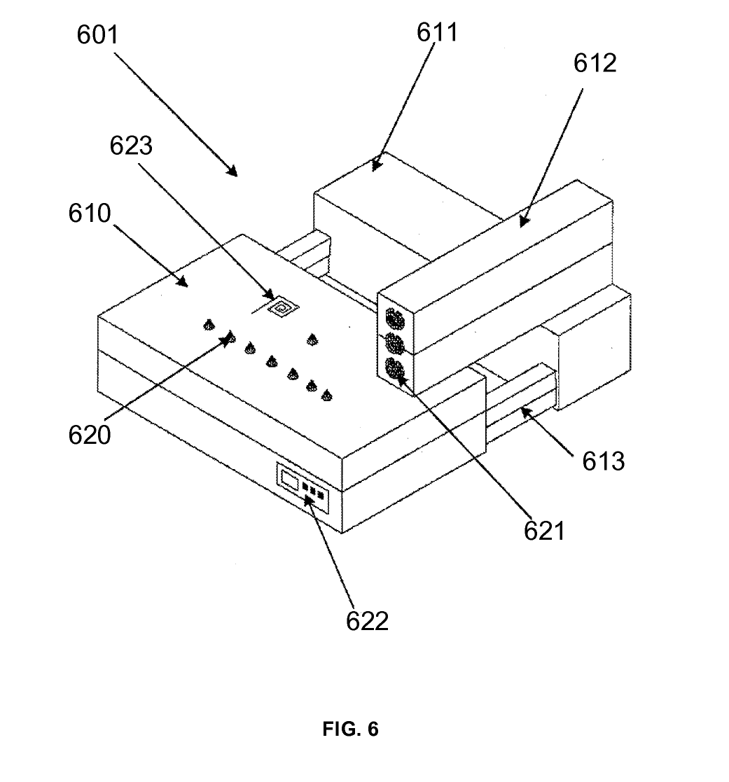

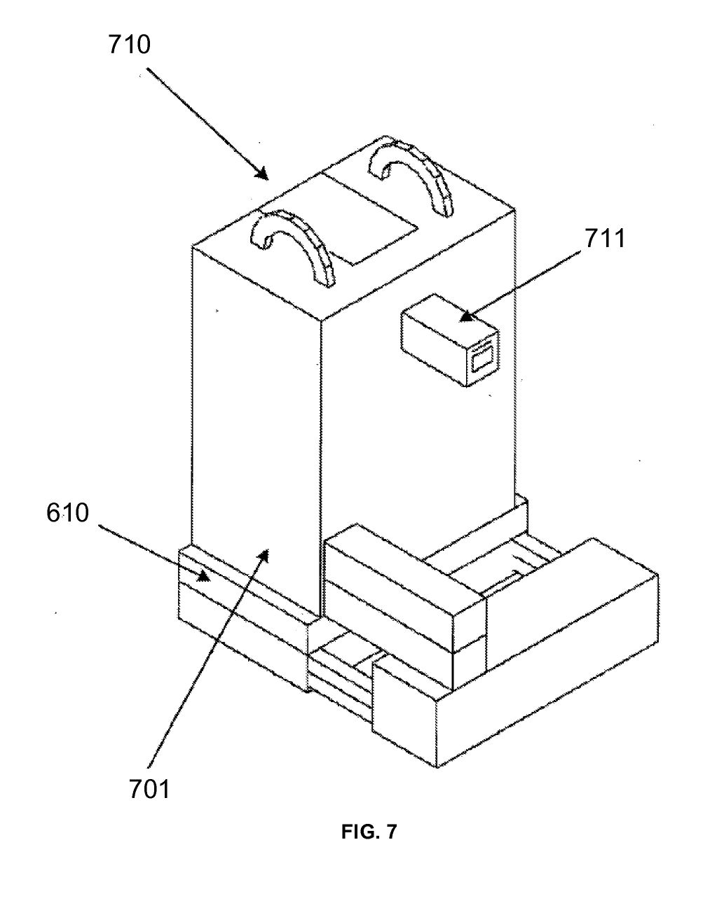

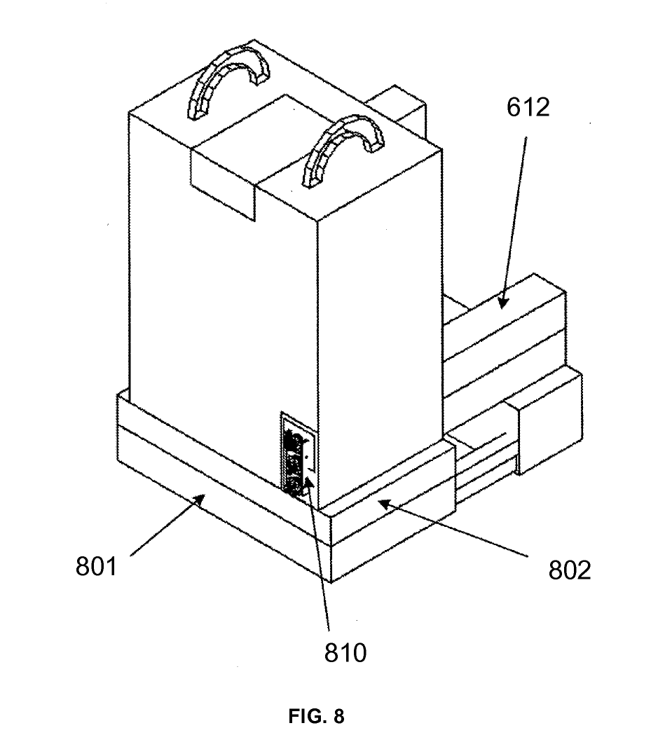

Proceeding to FIG. 5A 510, the figure demonstrates an exemplary case for manufacturing where the processing tools are located in a serial fashion. A work product is moved from one tool to the next tool after a process is complete and then by moving the work product to the end of the processing tools a complete product is obtained. A somewhat different condition is demonstrated in FIG. 5B 520, where the processing tools are assembled in a serial fashion; however the automation and the processing flow entails the work product moving from certain tools back to tools that were previously involved in processing and perhaps forwards to tools not yet involved in processing. The characteristics of such a flow may allow for improved cost aspects for end products, but may result in much more complicated operational control and planning.

A different situation is again demonstrated in FIG. 5C 530. In this type of flow there may be multiple tools of a particular tool type, or of all tool types. When a substrate proceeds to a particular tool type it may then be processed by one of a multiple number of tools of that type. This situation as well has more complicated logistics than the first example in FIG. 5A 510. However, advantages in the logistical flow can be quite important. For example if one of the processing tools of a particular type is not functioning and may need to be repaired, the work flow may proceed through one of the equivalent types of tools without the significant delays that would happen in a linear processing flow with one tool at each process step.

A still further different manufacturing condition may be demonstrated in FIG. 5D 540 where there are multiple tools of the various types and the processing can proceed in a haphazard manner from one tool type to another until the processing is complete. This is still higher in complexity than any of the other situations discussed. There may be numerous manners to operate a production flow of this type including for example allowing any work product to go through any of the multiple tools at a particular processing step to having dedicated tools for the processing at a particular processing step in the work product flow where use of other tools is only done under special circumstances.

Each of these types of manufacturing flows may be consistent with retrofitting to a fabricator of a Cleanspace type. As an example consider the example of FIG. 5E 561. In this there may be an exemplary manufacturing line 550 of the types shown previously. The line may have numerous tools as for example, one of them being tool 555.

Furthermore, the work product may be moved from tool to tool on an automation system 560. In an exemplary sense, it may be necessary to retrofit this manufacturing line because it may have been determined that the environment of manufacturing line 510 is of an insufficient cleanliness level.

In FIG. 5F, there may be an example of a Cleanspace Fabricator 580 that is a possible design to retrofit the manufacturing line into. This design would have the processing tools 590, arranged in a matrix along horizontal rows extending multiple levels in a vertical direction. The design has a Cleanspace 570 for the movement of substrates or Vessels from tool to tool. In the region of Cleanspace 570 there may be located automation systems that handle substrates or Vessels or in some examples substrates or Vessels inside substrate carriers. By appropriate flow of filtered air, the region may be brought to a very good cleanliness level. Furthermore, due to the nature of the design the space used for the automation and movement may be very small; a fact that allows for efficient operations and an easier environment to treat in cases where the cleanliness needs refer both to particulate forms and biological forms.

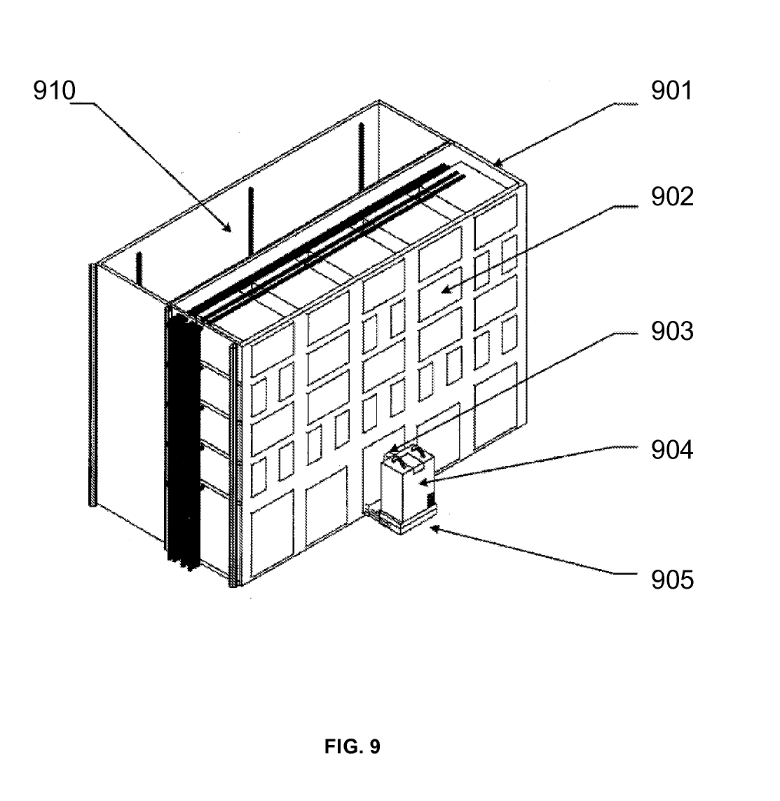

Referring now to FIG. 6 a chassis 601 is illustrated according to some examples of the present disclosure. Chassis plate 610 and fixed plate 611 may be attached to a sliding rail system 613 to provide an installation location for a processing Tool Body (not illustrated, for clarity). Fixed plate 611 is physically fixed in an appropriate location of a fabricator. In some examples, fixed plate 611 would not interact directly with the Tool Body, however, in some examples, a Tool Body can be fixedly attached to the fixed plate 611. In both examples, chassis plate 610 can physically support a Tool Body mounted on the chassis 601.

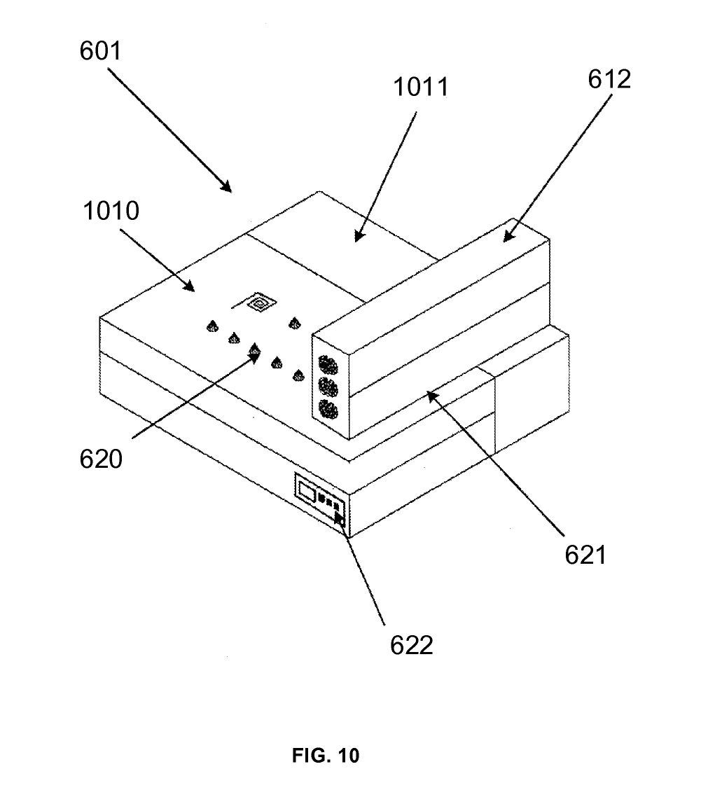

In FIG. 6, the orientation of two plates, chassis plate 610 and fixed plate 611 is shown with the base plates separated. The chassis 601 can have multiple service location orientations. A first location, as shown in the drawing, can involve an extended location, such that the placement and removal of a Tool Body from the chassis plate 610 can occur in an exposed location. An exposed location, for example, can facilitate placement of a new tool onto the chassis 601. A second service location allows the chassis 601 to relocate such the chassis plate 610 is now close to the fixed plate 611. An illustration of an exemplary second service location is provided in FIG. 10 including renumbered chassis plate 1010 and fixed plate 1011 to highlight their proximity.

In some examples, physical tabs 620 may stick out of the chassis plate 610. The physical tabs 620 may serve one or more purposes. As a physical extension, the physical tabs 620 will have a corresponding indentation (not illustrated) in the mating plate or a surface of a Tool Body to be placed on the physical tabs 620. As the Tool Body is lowered over the chassis 601, the Tool Body will reach a location as defined by physical tabs 620. In some examples, the physical tabs 620 can additionally provide electrical connection between the chassis plate 610 and the Tool Body. Electrical connection can serve one or more of the purposes of: electrical power connection and electrical data signal connection.

In some examples, a wireless interface 623 can provide wireless electrical connection between the Tool Body and the chassis. The wireless interface 623 can be redundant to hardwire data connections or take the place of hardwire data connection. The wireless interface can also be utilized for other electrical connections. In some examples, a wireless interface 623 can provide one or both of electrical power and data communication.

Connections for non-electrical utilities may be provided by fixtures 621. Fixtures 621 can be used for defining a connection, for example, of one or more of: gas, vacuum, fluids waste lines, compresses air, deionized water, chemicals and the like. Conduits 612 can carry these utilities to the fixtures 621 and be routed, for example, through the chassis 601. The conduits 612 can be connected to appropriate facility supply systems, air flow systems and drains to provide for safe operation.

Referring now to FIG. 7, a Tool Body 701 can be placed onto the chassis plate 610. The Tool Body 701 is illustrated in a generic box, however, any type of processing tool, such as those required for semiconductor manufacture or pharmaceutical or chemical manufacture of materials contained in a Vessel, is within the scope of the disclosure. In some examples, the underside of a Tool Body 701 can include a mating plate which physically interfaces with a chassis plate 610.

The present disclosure includes apparatus to facilitate placement of processing tools 710 each with a Tool Port 711 and their Tool Body 701 in a fab and the methods for using such placement. The chassis design can be capable of assuming two defined positions; one extended position places an interface plate external to the environment that the tool assumes when it is processing. This allows for easy placement and removal. The other position can be the location where the tooling sits when it is capable of processing.

The exact placement of the tooling afforded by the chassis 601 allows for more rational interconnection to facilities and utilities and also for the interfacing of the Tool Body 701 with fab automation. The chassis 601 can have automated operations capabilities that interface with the Tool Body and the fab operation to ensure safe controlled operation.

In another aspect of the disclosure, processing tools 710 can transfer a material, such as, for example, a Vessel containing a pharmaceutical material, in and out of a Tool Body 701. In FIG. 7, a Tool Port 711 can be used for coordinating transfer of a material into and out of the Tool Port 711 and maintaining Cleanspace integrity of a Tool Body 701 interior. As can be seen in FIG. 7 this example contemplates placing the Tool Port 711 in a manner physically connected to the Tool Body 701. A further purpose of the movement of the chassis plate 610 from its extended position to its closed position would be the movement of the Tool Port 711 through an opening in a clean space wall. This would allow the Tool Port 711 to occupy a position in a clean space so that fabricator logistics equipment can hand off Vessels and carriers of Vessels to the Tool Port 711.

Referring now to FIG. 8, in some examples, a Tool Body 801 can include a specifically located set of mating pieces with tool connections 810 for connecting the Tool Body 801 and its base plate 802 to facility supplied utilities. When the tool and chassis are moved from an extended position as shown in FIG. 6 to a closed position as shown in FIG. 10, such movement can place tool connections 810 in proximity to the facilities connections 612 at fixtures 621 and thereby allow for connection of various utilities. In some examples, as a processing tool is connected, various aspects of tool automation electronics can monitor the connection and determine when the connections are in a safe operating mode. Such tool automation electronics can communicate to the Tool Body 801 and to the tool chassis to identify a state that the connections and supply conduits are in.

In still another aspect of the disclosure, in some examples, control automation can be contained within the chassis for various aspects of the operation of the chassis. It is within the scope of the present disclosure to monitor and control multiple states related to the chassis via electronic included in the chassis. Such states can include, by way of example, a physical location of a chassis in an extended or closed state. Therefore, for example, if a processing tool and chassis are in a closed and operational state, a technical operator may issue a command to the chassis to move to an extended location. Such communication could occur through a control panel 622 or through wireless communication to the chassis 601 through wireless interface 623. Control of the processing tools can be accomplished with any known machine controller technology, including for example a processor running executable software and generating a human readable interface. In some examples, a processor running executable software may operate in an autonomous or semi-autonomous mode of operation.

In some examples, a command to move the chassis 601 to an extended location can also initiate, amongst other algorithmic functions, a check for the status of utilities connections. It is also within the scope of this disclosure to require any such utility connections to be rendered into a state of disconnect before the chassis 601 can proceed to an extended position.

Similarly, in some examples, prior to operations such as extension of a chassis 601, processing steps can determine that a Tool Body 801 did not contain any substrates or Vessels prior to extension of the chassis 601. It is also within the scope of the present disclosure for communication modes included within the chassis 601 to communicate with fab wide automation systems for purposes such as tracking the location of substrates or Vessels; tracking the identity of tools; and tracking the status of processing tools 710. If connections to the processing tool 710 and chassis 601 are in a proper state then the chassis can move into an extended position allowing for removal of the Tool Body 801 and replacement with a similar, Tool Body 801.

In some examples of the present disclosure, a fabricator will include automation to handle substrates or Vessels and control their processing. And, in many cases the substrates or Vessels can move from tool to tool in a specialized carrier which contains the substrates or Vessels. The specialized carriers can be transported via automation which includes automated transport systems. The carriers can thereby be presented to one or more processing tool interfaces, also referred to herein as a “port”. The automation allows for movement of the substrates or Vessels around the fab and for loading and unloading the substrates or Vessels from a processing tool. Substrates or Vessels can include, for example and without limitation, wafers for semiconductor processing, microelectronic machines, nanotechnology, photonic, and biotechnological carriers, test tubes, vials, flasks, columns and the like.

A substrate processing Tool Port can support processing tools and handle wafers and wafer carriers in an environment attached to the Tool Body. The Tool Port can penetrate a clean space containment wall and the Tool Body can enable routine placement and replacement into the fabricator environment.

As described above, according to the present disclosure, processing tools may reside with their tool bodies in a position which allows the Tool Body to be outside of a Cleanspace with a Tool Port operatively attached to the Tool Body inside of the Cleanspace. For example, examples can include a Tool Body adjacent to, or on the periphery of, a clean space of the fabricator and the Tool Port extending into the Cleanspace. Each Tool Body can be removed and replaced in a standardized process and without requiring the removal of adjacent tool bodies. The present disclosure also may anticipate the automated transfer of substrates or Vessels from a first Tool Port of a first processing tool to a second Tool Port of a second processing tool, while maintaining the substrate in a clean space environment via a clean carrier.

Examples therefore include Tool Ports that are capable of receiving a carrier or Vessel from the automated transport system. Each carrier or Vessel can contain at least one substrate. The automated transport unloads the carriers or Vessels and passes them off to the processing tools automation systems. In some examples, the port size enables it to span a wall used for the definition of a primary clean space of the fabricator. Inside the primary clean space resides the entry area of the Tool Port. The Tool Port's body can span a distance in excess of the width of the clean space wall to allow for substrates or Vessels which are unloaded from their carrier to be robotically handed off to the Tool Body's automation.

The Tool Port can incorporate various levels of automated carrier, substrate and Vessel handling apparatus. For example, in some examples, the carrier and Vessel handling apparatus can include communication systems which receive data from electronic sensors monitoring each port, processing tools and transport apparatus. In another aspect, a substrate or Vessel can be contained within a controlled ambient environment while it is within the storage carrier, port and processing tool.

FIG. 9 illustrates a perspective view of how a Tool Port 903 according to the present disclosure is operatively attached to a tool which is easily placed and replaced. In some examples, a fabricator 901 has a series of stacked tools, with the example tool 902. When a tool 902 is being placed or replaced it sits in a retracted position as illustrated with the tool in refracted position 905 relative to a normal position as illustrated with the position of tool 902 in a fabricator. The Tool Body, 904, is shown in its retracted position 905. As illustrated, the Tool Port 903 is located on a side of the Tool Body 904 with the furthest edge just visible.

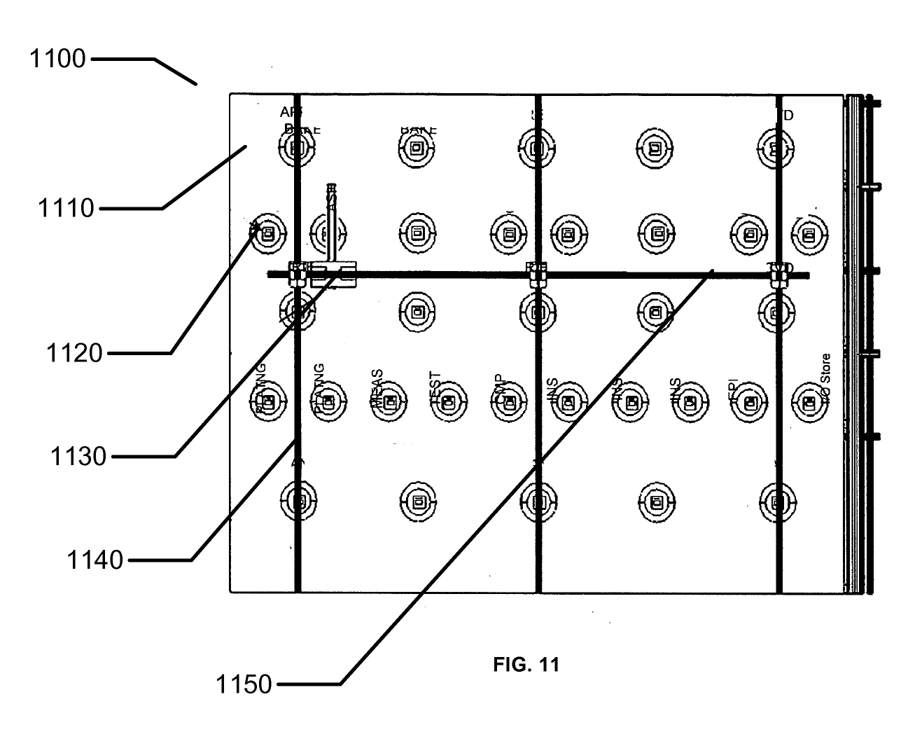

Referring to FIG. 11 1100, a depiction of the inside of the Primary Cleanspace 910 of FIG. 9 while looking at the wall adjacent to the tool positions, which in this drawing is now represented in a plan view 1110 may be observed. Multiple Tool Ports 1120 may be represented as the round shaped features. In this perspective view the automation may, in a non-limiting example example, consist of linear rails that allow movement along a vertical dimension 1140, for example and along a horizontal dimension 1150. The automation handler 1130 may receive carriers or substrates or Vessels. It may be noticed in this example that since the automation is able to address any Tool Port by a direct movement from a first Tool Port that the layout of the tool bodies and the associated location of the Tool Ports may be less structured as compared to previous examples. As may be apparent, there may be numerous manners to deploy tools and handle substrates or Vessels within the Primary Cleanspace that would be consistent with the art herein.

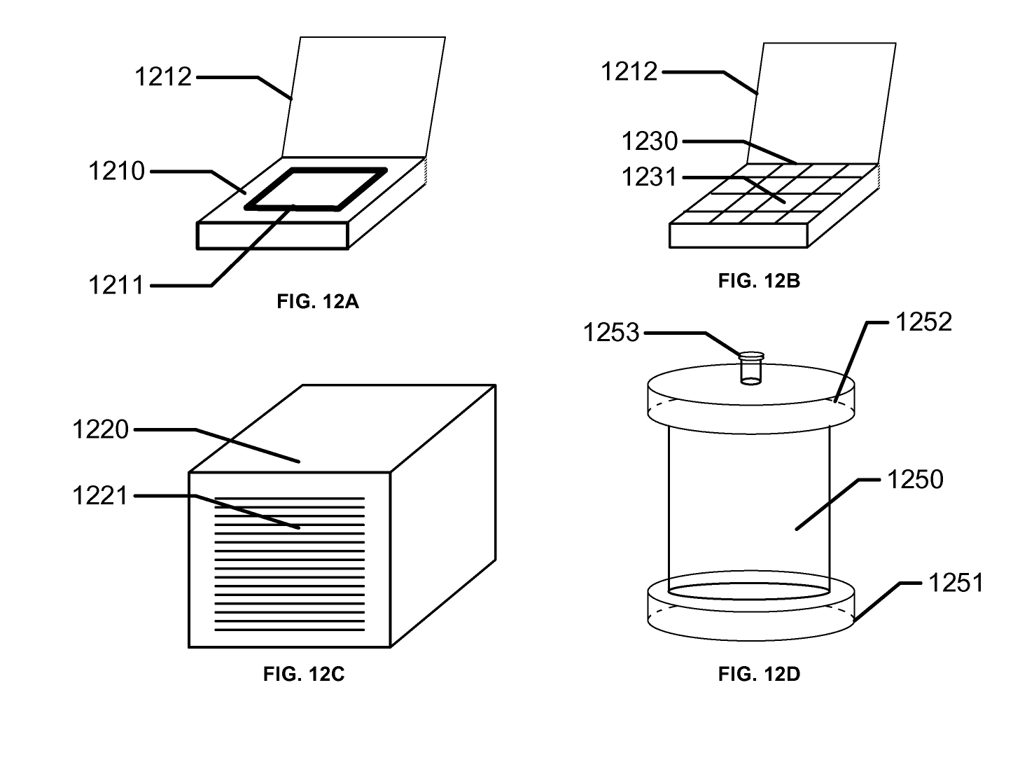

Proceeding to FIGS. 12A-12D, there have been numerous mentions of the fact that the Cleanspace Fabricator and the automation within it may handle substrates or Vessels or carriers that contain a substrate or multiple substrates or Vessels. There may be a carrier 1210 that contains a single Vessel or well 1211. The well or Vessel may be of various types of shapes and may have a lid 1212.

There may be a carrier 1220 that may contain numerous substrates or Vessels 1221, within it. The same diversity of shapes and materials may comprise acceptable types of carriers or Vessels. The carrier or Vessel itself may be capable of supporting a protected clean environment within its boundaries. In a non-limiting exemplary sense, when the carrier is containing fluids some of the carriers may comprise tubes or syringes or flasks. However, any carrier capable of containing substrates or Vessels and being handled by automation in the manners previously described would constitute acceptable examples of the art herein.

Sometimes the substrates or Vessels may be contained within a carrier where the substrates or Vessels or wells are located next to each other. There may be an exemplary well 1231 contained in such a carrier 1230 and may have a lid 1212. These individual cells or wells may contain various shapes and materials as substrates or Vessels. Here too, in some examples, the carrier may be able to maintain a clean environment around the substrates or Vessels as they are transported. Still further diversity may come from the fact that the entire item may be considered a carrier 1230 with multiple wells that will be processed with processing tools to form a product or products within the wells 1231, of the carrier 1230.

Referring to FIG. 12D a Vessel may be demonstrated for the containment of both powder and liquid materials. In some examples, the body of the Vessel 1250 may be formed of metals or glasses that are hollow or tube-like in shape. On the ends of the body of the Vessel 1250 may be caps 1251 and 1252 that may seal to the body to create a containment region within the Vessels. In some examples, the caps 1251 and 1252 may screw onto place over the body, in others they may be affixed to the body in various manners. One or more of the end caps may have additional means such as a feature 1253 that may be useful in filling and emptying the Vessel. The feature at 1253 may include sealing material that may be injected into or through with needles, or in other examples may be a valve or removable cap to allow for access to the material within the body of the container or Vessel 1250.

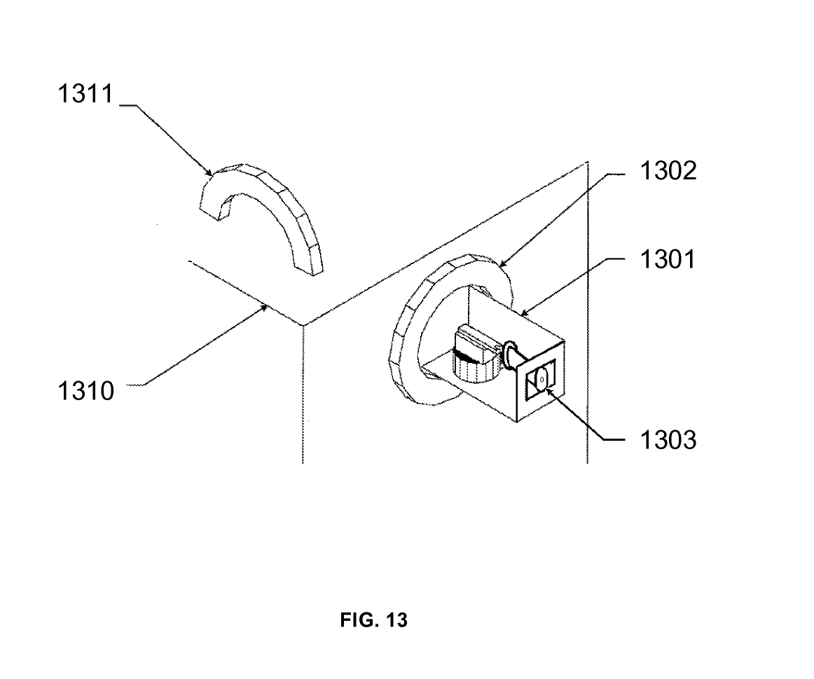

Referring now to FIG. 13, Tool Body 1310 with an exemplary handle 1311 is shown at a closer perspective including a seal 1302 around the Tool Port 1301 and side panels around the inside removed. The close up may demonstrate how a Vessel 1303 may be handled within a Tool Port to be placed within the processing area of the tool. The Vessel, 1303 may be transported throughout the fabricator by automation in the various manners discussed.

A more general design of the fabricator may comprise a vertically deployed automation space. In each of the examples that have been described herein, a Cleanspace may be viewed as an automation space that happens to achieve a particular level of cleanliness. In some examples, the cleanliness level may be relatively unclean or in some examples, the vertically deployed automation space may not even have active aspects that improve the level of cleanliness of the space but the clean aspect may refer to sanitary or sterilized aspects of the space.

In the processing of Vessels there may be various chemical and biological processing steps in a non limiting perspective that are performed. Pharmaceuticals, growing organisms, bioengineering products, antibiotics, pills and other such products may be produced using the various examples described herein. Some of these products may include additional cleanliness aspects in the production processes. Therefore, the environment of primary and Secondary Cleanspace regions as well as regions within toolPods may have sterile, antiseptic or antibiological aspects that may be supplementary to particulate control and may involve, in a non-limiting sense, high energy sources such as UV light, chemical and gas phase sterilizing materials and such techniques.

### Glossary of Selected Terms

Reference may have been made to different aspects of some preferred examples of the disclosure, examples of which are illustrated in the accompanying drawings. A Glossary of Selected Terms is included now at the end of this Detailed Description.
Air receiving wall: a boundary wall of a Cleanspace that receives air flow from the Cleanspace.
Air source wall: a boundary wall of a Cleanspace that is a source of clean airflow into the Cleanspace.
Annular: The space defined by the bounding of an area between two closed shapes one of which is internal to the other.
Automation: The techniques and equipment used to achieve automatic operation, control or transportation.
Ballroom: A large open cleanroom space devoid in large part of support beams and walls wherein tools, equipment, operators and production materials reside.
Batches: A collection of multiple substrates or Vessels to be handled or processed together as an entity
Boundaries: A border or limit between two distinct spaces—in most cases herein as between two regions with different air particulate cleanliness levels.
Circular: A shape that is or nearly approximates a circle.
Clean: A state of being free from dirt, stain, or impurities—in most cases herein referring to the state of low airborne levels of particulate matter and gaseous forms of contamination.
Cleanspace (or equivalently Clean Space): A volume of air, separated by boundaries from ambient air spaces, that is clean.
Cleanspace, Primary: A Cleanspace whose function, perhaps among other functions, is the transport of jobs between tools.
Cleanspace, Secondary: A Cleanspace in which jobs are not transported but which exists for other functions, for example as where tool bodies may be located.
Cleanroom: A Cleanspace where the boundaries are formed into the typical aspects of a room, with walls, a ceiling and a floor.
Conductive Connection: a joining of two entities which are capable of conducting electrical current with the resulting characteristics of metallic or semi-conductive or relatively low resistivity materials.
Conductive Contact: a location on an electrical device or package having the function of providing a Conductive Surface to which a Conductive Connection may be made with another device, wire or electrically conductive entity.
Conductive Surface: a surface region capable of forming a conductive connection through which electrical current flow may occur consistent with the nature of a conductive connection.
Core: A segmented region of a standard cleanroom that is maintained at a different clean level. A typical use of a core is for locating the processing tools.
Ducting: Enclosed passages or channels for conveying a substance, especially a liquid or gas—typically herein for the conveyance of air.
Envelope: An enclosing structure typically forming an outer boundary of a Cleanspace.
Fab (or fabricator): An entity made up of tools, facilities and a Cleanspace that is used to process substrates or Vessels.
Fit up: The process of installing into a new clean room the processing tools and automation it is designed to contain.
Flange: A protruding rim, edge, rib, or collar, used to strengthen an object, hold it in place, or attach it to another object. Typically herein, also to seal the region around the attachment.
Folding: A process of adding or changing curvature.
HEPA: An acronym standing for high-efficiency particulate air. Used to define the type of filtration systems used to clean air.
Horizontal: A direction that is, or is close to being, perpendicular to the direction of gravitational force.
Job: A collection of substrates or Vessels or a single substrate that is identified as a processing unit in a fab. This unit being relevant to transportation from one processing tool to another.
Logistics: A name for the general steps involved in transporting a job from one processing step to the next. Logistics can also encompass defining the correct tooling to perform a processing step and the scheduling of a processing step.
Maintenance Process: A series of steps that constitute the repair or retrofit of a tool or a toolPod. The steps may include aspects of disassembly, assembly, calibration, component replacement or repair, component inter-alignment, or other such actions which restore, improve or insure the continued operation of a tool or a toolPod
Multifaced: A shape having multiple faces or edges.
Nonsegmented Space: A space enclosed within a continuous external boundary, where any point on the external boundary can be connected by a straight line to any other point on the external boundary and such connecting line would not need to cross the external boundary defining the space.
Perforated: Having holes or penetrations through a surface region. Herein, said penetrations allowing air to flow through the surface.
Peripheral: Of, or relating to, a periphery.
Periphery: With respect to a Cleanspace, refers to a location that is on or near a boundary wall of such Cleanspace. A tool located at the periphery of a Primary Cleanspace can have its body at any one of the following three positions relative to a boundary wall of the Primary Cleanspace: (i) all of the body can be located on the side of the boundary wall that is outside the Primary Cleanspace, (ii) the Tool Body can intersect the boundary wall or (iii) all of the Tool Body can be located on the side of the boundary wall that is inside the Primary Cleanspace. For all three of these positions, the tool's port is inside the Primary Cleanspace. For positions (i) or (iii), the Tool Body is adjacent to, or near, the boundary wall, with nearness being a term relative to the overall dimensions of the Primary Cleanspace.
Planar: Having a shape approximating the characteristics of a plane.
Plane: A surface containing all the straight lines that connect any two points on it.
Polygonal: Having the shape of a closed figure bounded by three or more line segments
Process: A series of operations performed in the making or treatment of a product—herein primarily on the performing of said operations on substrates or Vessels.
Processing Chamber (or Chamber or Process Chamber): a region of a tool where a substrate resides or is contained within when it is receiving a process step or a portion of a process step that acts upon the substrate. Other parts of a tool may perform support, logistic or control functions to or on a processing chamber.
Process Flow: The order and nature of combination of multiple process steps that occur from one tool to at least a second tool. There may be consolidations that occur in the definition of the process steps that still constitute a process flow as for example in a single tool performing its operation on a substrate there may be numerous steps that occur on the substrate. In some cases these numerous steps may be called process steps in other cases the combination of all the steps in a single tool that occur in one single ordered flow may be considered a single process. In the second case, a flow that moves from a process in a first tool to a process in a second tool may be a two-step process flow.
Production unit: An element of a process that is acted on by processing tools to produce products. In some Cleanspace Fabricators this may include carriers and/or substrates or Vessels.
Robot: A machine or device that operates automatically or by remote control, whose function is typically to perform the operations that move a job between tools, or that handle substrates or Vessels within a tool.
Round: Any closed shape of continuous curvature.
Substrates: A body or base layer, forming a product, that supports itself and the result of processes performed on it.
Tool: A manufacturing entity designed to perform a processing step or multiple different processing steps. A tool can have the capability of interfacing with automation for handling jobs of substrates or Vessels. A tool can also have single or multiple integrated chambers or processing regions. A tool can interface to facilities support as necessary and can incorporate the necessary systems for controlling its processes.
Tool Body: That portion of a tool other than the portion forming its port.
Tool Chassis (or Chassis): An entity of equipment whose prime function is to mate, connect and/or interact with a toolPod. The interaction may include the supply of various utilities to the toolPod, the communication of various types of signals, the provision of power sources. In some examples a Tool Chassis may support, mate or interact with an intermediate piece of equipment such as a pumping system which may then mate, support, connect or interact with a toolPod. A prime function of a Tool Chassis may be to support easy removal and replacement of toolPods and/or intermediate equipment with toolPods.
toolPod (or tool Pod or Tool Pod or similar variants): A form of a tool wherein the tool exists within a container that may be easily handled. The toolPod may have both a Tool Body and also an attached Tool Port and the Tool Port may be attached outside the container or be contiguous to the tool container. The container may contain a small clean space region for the Tool Body and internal components of a tool Port. The toolPod may contain the necessary infrastructure to mate, connect and interact with a Tool Chassis. The toolPod may be easily transported for reversible removal from interaction with a primary clean space environment.
Tool Port: That portion of a tool forming a point of exit or entry for jobs to be processed by the tool. Thus the port provides an interface to any job-handling automation of the tool.
Tubular: Having a shape that can be described as any closed figure projected along its perpendicular and hollowed out to some extent.
Unidirectional: Describing a flow which has a tendency to proceed generally along a particular direction albeit not exclusively in a straight path. In clean airflow, the unidirectional characteristic is important to ensuring particulate matter is moved out of the Cleanspace.
Unobstructed removability: refers to geometric properties, of fabs constructed in accordance with the present disclosure that provide for a relatively unobstructed path by which a tool can be removed or installed.
Utilities: A broad term covering the entities created or used to support fabrication environments or their tooling, but not the processing tooling or processing space itself. This includes electricity, gasses, airflows, chemicals (and other bulk materials) and environmental controls (e.g., temperature).
Vertical: A direction that is, or is close to being, parallel to the direction of gravitational force.
Vertically Deployed Automation Space: a space whose major dimensions of span may fit into a plane or a bended plane whose normal has a component in a horizontal direction. A Vertically Deployed Automation Space may have automation tooling that transports material in at least a vertical direction between multiple levels of tools.
Vertically Deployed Cleanspace: a Cleanspace whose major dimensions of span may fit into a plane or a bended plane whose normal has a component in a horizontal direction. A Vertically Deployed Cleanspace may have a Cleanspace airflow with a major component in a horizontal direction. A Ballroom Cleanroom would typically not have the characteristics of a vertically deployed Cleanspace.
Vessel: an article that may be used to contain a product as the product is processed and/or transferred. By way of non-limiting example, a Vessel may include compartments such as wells or reservoirs of various types. A tube type Vessel with one or both ends capped may be used for Vessel processing. Regions of end caps may allow for injection of product material into the Vessel by various automation or manual material conveying apparatus. A Vessel, as used herein is of a size and shape conducive for conveyance through a Toolport.

While the disclosure has been described in conjunction with specific examples, it is evident that many alternatives, modifications and variations will be apparent to those skilled in the art in light of the foregoing description. Accordingly, this description is intended to embrace all such alternatives, modifications and variations as fall within its spirit and scope.

What is claimed is:

1) A method for processing a Vessel comprising:
receiving a fabricator comprising at least a first vertically deployed Cleanspace, at least a first tool chassis and at least a first toolPod attached to the first tool chassis;
processing a first Vessel in the first toolPod;
handling the first Vessel at a toolport of the first toolPod within the first vertically deployed Cleanspace;
removing the first toolPod from the fabricator from outside a Primary Cleanspace for repair; and
placing a second toolPod upon the first tool chassis.

2) The method of claim 1 wherein the second toolPod comprises a toolPod of a newer design.

3) The method of claim 1 wherein:
the processing of the first Vessel forms a product that contains one or more of a pharmaceutical, an intermediate in the production of a pharmaceutical, or a material with pharmaceutical properties.

4) A fabricator for containing a plurality of processing tools, the fabricator comprising:
a Vessel, wherein the Vessel is capable of being handled by a fabricator automation system;
multiple levels of processing tools, wherein at least a second level of processing tools is oriented vertically above at least a first level of processing tools, wherein a first processing tool on the first level of processing tools and a second processing tool on the second level are configured to process the Vessel;
a Primary Cleanspace bounded in part by a first vertical wall and a second vertical wall, wherein said Primary Cleanspace is located between the first vertical wall and the second vertical wall, wherein within the Primary Cleanspace the Vessel may be transported from the first level of processing tools to the second level of processing tools; and
an air source for providing air flow through the Primary Cleanspace from the first vertical wall to the second vertical wall.

5) The fabricator of claim 4 wherein the first processing tool comprises:
a Tool Port that receives Vessels from the fabricator automation;
a Tool Body that is interfaced to fabricator facilities including one or more of utilities, chemicals and gases; and
at least a first integrated chamber or processing region.

6) The fabricator of claim 4 wherein the first vertical wall and the second vertical wall are essentially planar.

7) The fabricator of claim 4 wherein:
a floor is located above at least a portion of the first level of processing tools; and
the floor is beneath at least a portion of the second level of processing tools.

8) The fabricator of claim 5 additionally comprising:
two or more flanges, each flange sealed to a respective opening in at least one of the vertical walls, each said flange additionally sealable to one of the plurality of fabrication tools.

9) The fabricator of claim 8 wherein:
each flange facilitates the containment of air within the Primary Cleanspace; and
at least a first Tool Port of the first processing tool is within the Primary Cleanspace while the first Tool Body of the first processing tool is external to the Primary Cleanspace.

10) The fabricator of claim 5 wherein:
each processing tool is capable of independent operation and is removable such that the removing does not prevent the operation of other processing tools.

11) The fabricator of claim 10 wherein the removal removes the tool from a Secondary Cleanspace.

12) The fabricator of claim 10 wherein:
a material to be processed by the plurality of tools can be transferred from a port of the first processing tool to a port of the second processing tool through the Primary Cleanspace.

13) The fabricator of claim 5 wherein the Vessel contains a pharmaceutical, an intermediate in the production of a pharmaceutical, or a material with pharmaceutical properties.

14) The fabricator of claim 4 additionally comprising: means for locating a Tool Body upon a tool chassis in at least an extended position and a closed position, wherein when the means for locating the Tool Body locates the Tool Body in the extended position the Tool Body may be removed from the tool chassis.

15) The fabricator of claim 5 additionally comprising:
means for interfacing a Tool Body to a tool chassis, wherein the means for interfacing establishes an interface between the Tool Body and the fabricator facilities.

16) A method of processing Vessels; the method comprising the step of:
moving a Vessel within a Primary Cleanspace comprised within a fabricator from a first processing tool to a second processing tool, wherein the Primary Cleanspace comprises a first vertical wall and a second vertical wall, wherein an air source within the fabricator provides air flow through the Primary Cleanspace from the first vertical wall to the second vertical wall, and wherein the first processing tool is located on a first level of processing tools and the second processing tool is located on a second level of processing tools.

17) The method of processing Vessels of claim 16 additionally comprising the step of performing a process on a content of the Vessel in the second processing tool.

18) The method of processing Vessels of claim 17 wherein the content is a liquid.

19) The method of processing Vessels of claim 17 wherein the content is a powder.

20) The method of processing substrates of claim 16 additionally comprising the steps:
replacing the first processing tool with a second processing tool from a peripheral location, such that the replacing does not prevent the operation of other processing tools in the fabricator.
